(19) United States
(12) Patent Application Publication
(10) Pub. No.: US 2014/0067573 A1
(43) Pub. Date: Mar. 6, 2014

(54) INFORMATION PROCESSING APPARATUS AND COMMODITY RECOGNITION METHOD BY THE SAME

(71) Applicant: TOSHIBA TEC KABUSHIKI KAISHA, Tokyo (JP)

(72) Inventors: Hidehiro Naito, Shizuoka-ken (JP); Hiroshi Sugasawa, Miyagi-ken (JP)

(73) Assignee: TOSHIBA TEC KABUSHIKI KAISHA, Tokyo (JP)

(21) Appl. No.: 13/868,232

(22) Filed: Apr. 23, 2013

(30) Foreign Application Priority Data
Sep. 6, 2012 (JP) 2012-196425

(51) Int. Cl. G06Q 20/20

(52) U.S. Cl. CPC G06Q 20/208
USPC 705/23

(57) ABSTRACT

According to one embodiment, an information processing apparatus includes an image capturing module, an extraction module, a recognition module, a determination module and an output module. The image capturing module photographs a commodity. The extraction module extracts a feature amount of the commodity contained in the image photographed. The recognition module recognizes the commodity as a commodity candidate in the feature amount the commodity. The determination module determines whether or not there is a commodity sold in a disparate sales form for the standard commodity which is recognized by the recognition module as a candidate. The output module outputs in a selectable manner information concerning the standard commodity recognized by the recognition module as a candidate and the commodity sold in a disparate sales form for the standard commodity if the determination module determines that there is a commodity sold in a disparate sales form.

### CROSS-REFERENCE TO RELATED APPLICATIONS

This application is based upon and claims the benefit of priority from the prior Japanese Patent Application No. 2012-196425, filed on Sep. 6, 2012, the entire contents of which are incorporated herein by reference.

### FIELD

Embodiments described herein relate to an information processing apparatus and a commodity recognition method executed by the information processing apparatus.

### BACKGROUND

In the past, a technology is proposed in which the feature amount (e.g. shape) of a commodity is acquired from an image data of the commodity photographed and a candidate of the recognition commodity is determined based on the acquired feature amount.

However, in a store such as a supermarket and the like, there is a case that a commodity, e.g., fresh vegetables or fruits, is sometimes sold in different sales forms, for example, such that the commodity is prepared in one bunch or block unit or a half thereof even those are the same commodities.

In this case, however, if the commodity is photographed from a direction that the state of sales thereof is hardly distinguished such that an uncut surface of the commodity is photographed, there may be a possibility that the photographed commodity is not recognized as a commodity being cut in half, for example. The technology conventionally proposed remains to be improved.

### BRIEF DESCRIPTION OF THE DRAWINGS

FIG. 1 is a perspective view of the external construction of a checkout system according to an embodiment;

FIG. 2 is a block diagram illustrating the hardware configuration of a POS terminal and a commodity reading apparatus shown in FIG. 1;

FIG. 3 is a schematic diagram illustrating an example of the data configuration of a PLU file shown in FIG. 2;

FIG. 4 is a block diagram illustrating the functional configuration of the POS terminal and the commodity reading apparatus shown in FIG. 1;

FIG. 5 is a diagram illustrating an example of a commodity candidate displayed on the display device of the commodity reading apparatus;

FIG. 6 is a diagram illustrating an example of a commodity candidate displayed on the display device of the commodity reading apparatus;

FIG. 7 is a flow chart illustrating the procedure of a commodity recognition processing carried out by the commodity reading apparatus;

FIG. 8 is a flow chart illustrating the procedure of a sales registration processing carried out by the POS terminal;

FIG. 9 is a perspective view illustrating the configuration of a self-checkout POS according to an embodiment;

FIG. 10 is a block diagram illustrating the hardware configuration of the self-checkout POS terminal shown in FIG. 9.

### DETAILED DESCRIPTION

In general, according to one embodiment, an information processing apparatus includes an image capturing module, an extraction module, a recognition module, a determination module and an output module. The image capturing module photographs a commodity. The extraction module extracts a feature amount of the commodity contained in the image photographed by the image capturing module. The recognition module calculates a value representing the relationship between a first feature amount extracted by the extraction module and a second feature amount of each standard commodity serving as a reference by comparing the first feature amount with the second feature amount to recognize a standard commodity having a similarity degree greater than a threshold as a commodity candidate. The determination module determines whether or not there is a commodity sold in a disparate sales form for the standard commodity which is recognized by the recognition module as a candidate. The output module outputs in a selectable manner information concerning the standard commodity recognized by the recognition module as a candidate and the commodity sold in a disparate sales form for the standard commodity if the determination module determines that there is a commodity sold in a disparate sales form.

Embodiments of the information processing apparatus and method thereof are described below with reference to the accompanying drawings. The embodiments are only illustrative of but are not to be construed as limiting the configuration and specification and the like of the information processing apparatus. The embodiments described herein are application examples of a checkout system, including a POS terminal and a commodity reading apparatus, which is installed in a supermarket or store. The POS terminal executes a registration and settlement of a commodity in one transaction and the commodity reading apparatus reads information relating to the commodity.

### First Embodiment

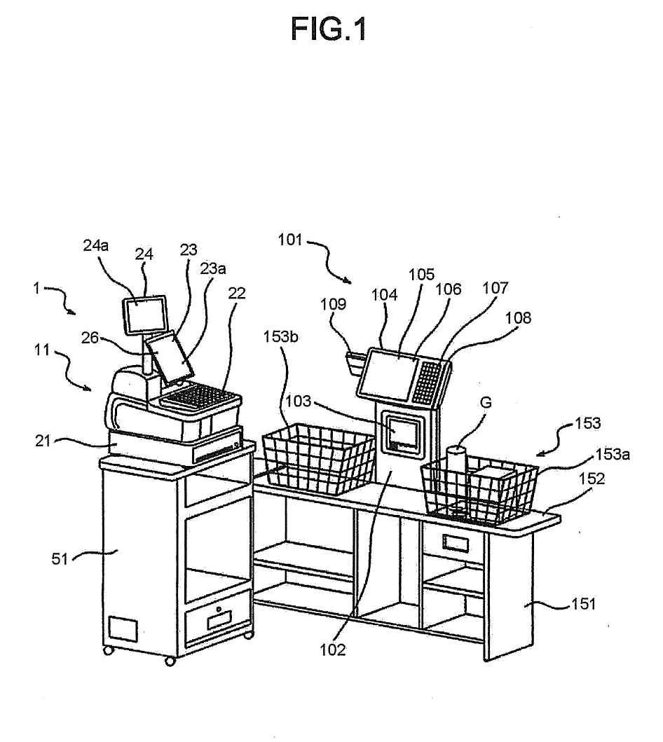

FIG. 1 is a perspective view of the external construction of a checkout system 1. As shown in FIG. 1, the checkout system 1 comprises a POS terminal 11 and a commodity reading apparatus 101 serving as an information processing apparatus.

The POS terminal 11 is placed on the upper surface of a drawer 21 arranged on a checkout counter 51. The drawer 21 is opened under the control of the POS terminal 11. A keyboard 22 which is operated by an operator (shop clerk) is arranged on the upper surface of the POS terminal 11. A display for operator 23 for displaying information to the operator is arranged at a back side through the keyboard 22 from the operator who operates the keyboard 22. The display for operator 23 displays information on the display surface 23a thereof. A touch panel 26 is laminated on the display surface 23a.

A display for customer 24 is arranged in a free rotatable manner at a further back side to the display for operator 23. The display for customer 24 displays information on the display surface 24a thereof.

The display surface 24a of the display for customer 24 shown in FIG. 1 faces the operator, but it is rotated so that the display surface 24a faces a customer to display information to a customer.

A horizontally long table-shaped counter 151 is arranged such that it is located in a right angle to the checkout counter 51 on which the POS terminal 11 is placed. A receiving surface 152 is formed on the upper surface of the counter 151. A shopping basket 153 for accommodating a commodity G is placed on the receiving surface 152. The shopping basket 153 includes a first shopping basket 153a, placed on the counter 51 at a side, which is held by a customer and a second shopping basket 153b which is placed on the counter 51 at a side opposite to the first shopping basket 153a through the commodity reading apparatus 101.

The commodity reading apparatus 101 connected with the POS terminal 11 to perform transmission of data is arranged on the receiving surface 152 of the counter 151. The commodity reading apparatus 101 has a thin rectangular shaped housing 102.

A reading window 103 is arranged at the front side of the housing 102. A display operation section 104 is arranged on the upper part of the housing 102. A display device 106 having a touch panel 105 laminated on the surface thereof is arranged on the display operation section 104. A keyboard 107 is arranged at the right-hand side of the display device 106. The card reading slot 108 of a card reader (not shown) is arranged at the right-hand side of the keyboard 107. A display for customer 109 is arranged at the left-hand side of the display operation section 104 with respect to the operator to provide information to a customer.

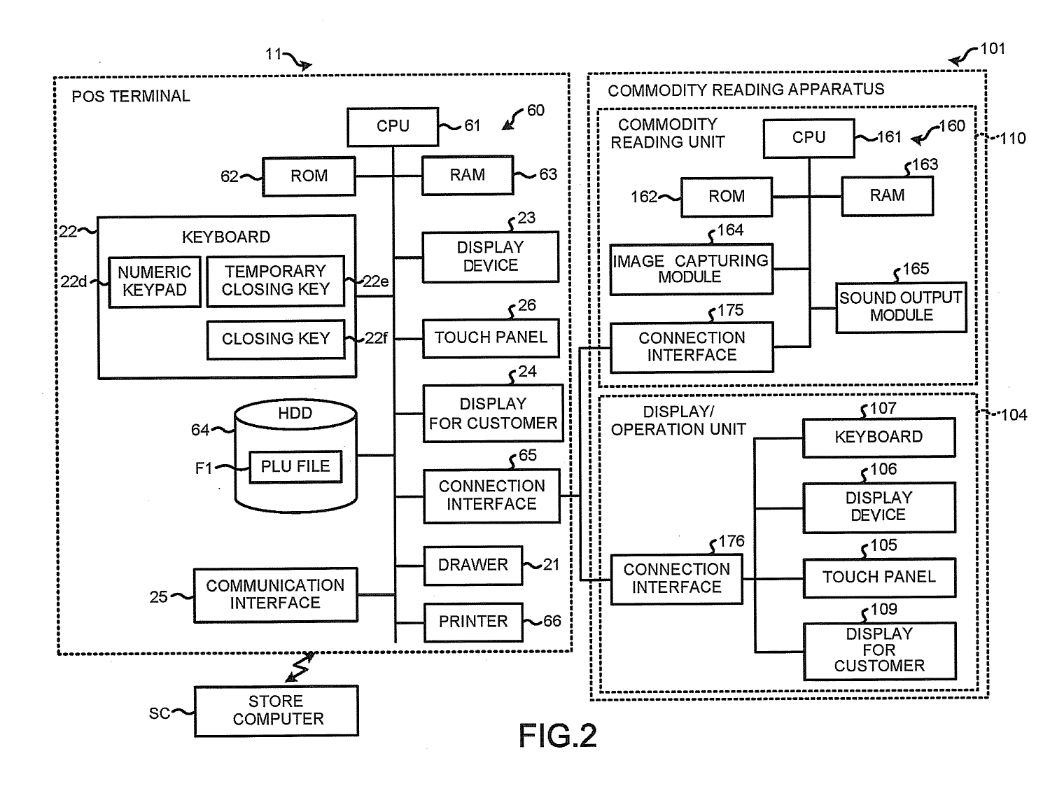

Commodities G in one translation are housed in the first shopping basket 153a carried by the customer. The commodities G in the first shopping basket 153a are moved one by one to the second shopping basket 153b by the operator who operates the commodity reading apparatus 101. While moving the commodity from the first shopping basket 153a, the commodity G is exposed to the reading window 103 of the commodity reading apparatus 101. At this time, the image capturing module 164 (refer to FIG. 2) arranged inside the reading window 103 photographs the commodity G.

FIG. 2 is a block diagram illustrating the hardware configuration of the POS terminal and the commodity reading apparatus 101.

The POS terminal 11 is provided with a microcomputer 60 functioning as an information processing unit for carrying out an information processing. The microcomputer 60 includes a CPU (Central Processing Unit) 61 for carrying out various operations to control each section, a ROM (Read Only Memory) 62 and a RAM (Random Access Memory) 63 connected via a bus line.

The drawer 21, the keyboard 22, the display device 23, the display for customer 24, the communication interface 25 and the touch panel 26 are connected with the CPU 61 of the POS terminal 11 via various input/output circuits (not shown).

The keyboard 22 includes a numeric keypad 22d on which numeric characters such as ‘1’, ‘2’, ‘3’ and a multiplying operator such as ‘*’ are indicated, a temporary closing key 22e and a closing key 22F. The CPU 61 of the POS terminal 11 is connected with an HDD (Hard Disk Drive) 64, in which various programs and files are stored. Programs and files stored in the HDD 64 are copied in all or in part onto the area of the RAM 63 and are executed by the CPU 61 when the POS terminal 11 is activated.

The HDD 64 stores a data file such as a PLU file F1 and the like. The PLU file F1 is readable by the commodity reading apparatus 101 through a connection interface 65.

The PLU file F1 is a data file in which a commodity G sold in a store is associated with information concerning the sales registration of the commodity G.

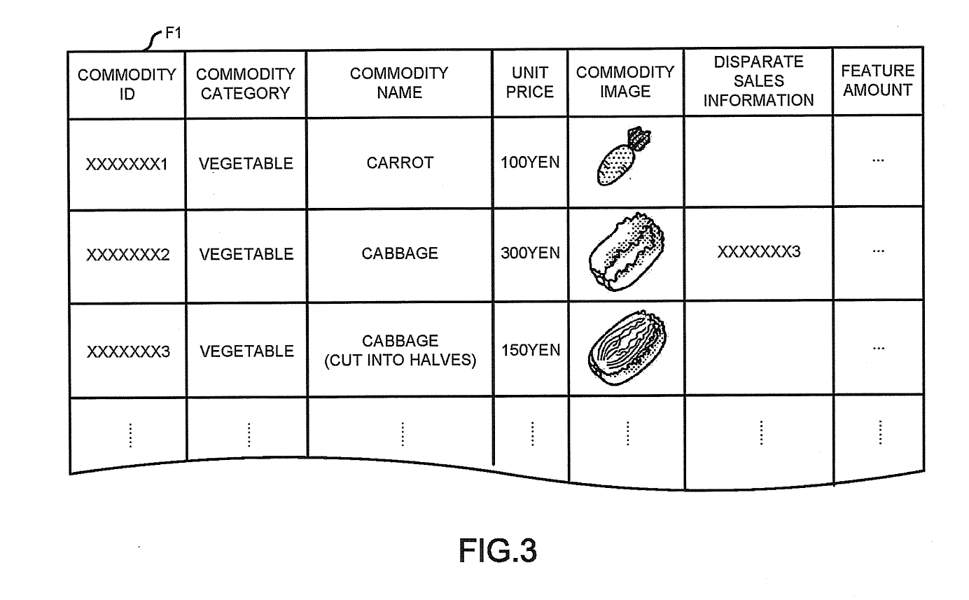

FIG. 3 is a schematic diagram illustrating an example of the data configuration of the PLU file F1. As shown in FIG. 3, for each commodity G, a unique commodity ID is registered in association with information relating to a commodity (such as a commodity category to which a commodity belongs, a commodity name, a unit price, etc.), an image of the commodity photographed and a disparate sales information showing whether or not there is other commodity sold in a different form for the same commodity. In addition, the feature amount (feature amount data of a standard commodity) of each commodity G is registered (stored) in advance in the PLU file F1 in an associated manner.

The commodity image is a standard image (reference image) obtained by photographing each commodity G as a standard commodity. The commodity image is showed as a commodity candidate described later when the commodity candidate is presented. It is preferable to show, as a commodity image, an image illustrating the sales form of the commodity, for example, for a commodity sold in a form in which it is cut, and the commodity image that the cut surface of the commodity is photographed is used.

If a commodity G is sold in a plurality of sales forms in the same commodity G, the commodity ID of the commodity G sold in a different sales form to the same commodity G sold in a standard sales form is added to the commodity G sold in the standard sales form as disparate sales information. For example, in FIG. 3, for a commodity ‘chinese cabbage’, the commodity ID “XXXXXXX3” of the commodity ‘chinese cabbage’ sold in a form in which it is cut in half is registered as a disparate sales information to the commodity ‘chinese cabbage’ of the commodity ID ‘XXXXXXX2’ sold in a whole unit. The commodity registered in a PLU file F1 is hereinafter referred to as a registered commodity. A registered commodity represented by disparate sales information is referred to as a disparate sales commodity (commodity in disparate sales form).

Further, the feature amount of a commodity G previously extracted from the photographed image (e.g. commodity image) of each commodity G is registered in association with a corresponding commodity ID. The feature amount refers to information representing the feature of the commodity G, such as an external tint, a pattern, a concave-convex condition and a shape.

According to the present embodiment, in a commodity G sold in a plurality of different forms, the commodity ID of the commodity G sold in a sales form different from a standard sales form thereof registered is added to the same commodity sold in the standard sales form as disparate sales information. However, the present embodiment is not limited to this, and the commodity IDs of a registered commodity sold in one sales form (disparate, sales commodity) and a registered same commodity sold in another sales form may be mutually added to one and another commodities as disparate sales information.

Further, in the present embodiment, the commodity ID of a commodity sold in a disparate sales form is used as disparate sales information. However, the present embodiment is not limited to this. A commodity name and the file name of a commodity image capable of specifying the commodity ID of a commodity sold in a disparate sales form may be used. In addition to this, the storage location (storage address in the PLU file F1) of the commodity ID may also be used as disparate sales information.

Still further, in the present embodiment, the commodity image of each registered commodity is stored in the PLU file F1. However, the present embodiment is not limited to this. The commodity image of each registered commodity may also be stored in a data file different from the PLU file F1 in association with a corresponding commodity ID. Further, in the present embodiment, the feature amount of each commodity G is previously registered in the PLU file F1. However, the present embodiment is not limited to this, and the feature amount of each commodity may also be extracted from the image of the commodity by a feature amount extraction module 1613 described later. An image for presentation may be registered instead of a commodity image.

Return to FIG. 2, the CPU 61 of the POS terminal 11 is connected with a communication interface 25, which transmits data with the store computer SC, via an input-output circuit (not shown). The store computer SC is installed in the backyard of a store. The HDD (not shown) of the store computer SC stores the PLU file F1, which is distributed to the POS terminal 11.

The connection interface 65 enables transmission and reception of data with the commodity reading apparatus 101. The connection interface 65 is connected with the commodity reading apparatus 101. A printer 66 performs printing on a receipt and the like. The POS terminal 11 enables the printer 66 to print content of one transaction on a receipt under the control of the CPU 61.

The commodity reading apparatus 101 comprises a commodity reading section 110 and a display-operation section 104. The commodity reading section 110 is provided with a microcomputer 160, which is formed with a CPU 161 and, a ROM 162 and a RAM 163 connected to the CPU 161 via a bus line. The ROM 162 stores programs executed by the CPU 161.

The CPU 161 is connected with the image capturing module 164, a sound output module 165 and a connection interface 175 via various input/output circuits (not shown). The image capturing module 164, the sound output module 165 and the connection interface 175 are controlled by the CPU 161.

The image capturing module 164 includes a color CCD sensor or a color CMOS sensor, and performs the image capturing through the reading window 103, as an image capturing element. For example, the image capturing module 164 captures dynamic images at 30 fps. The frame images (captured images) sequentially captured by the image capturing module 164 at a given frame rate are stored in the RAM 163. The sound output module 165 includes a voice circuit and loudspeaker that generate a preset warning sounds. Under the control of the CPU 161, the sound output module 165 gives a notice by the warning sound.

The display-operation section 104 comprises a touch panel 105, a display device 106, a keyboard 107, a display for customer 109 and a connection interface 176. The connection interface 175 of the commodity reading section 110 is connected with the connection interface 65 of the POS terminal 11 to perform transmission/reception of data with the POS terminal 11. The connection interface 175 is connected with the display-operation section 104 via a connection interface 176, and the CPU 161 performs transmission/reception of data with the commodity reading section 110 and the display-operation section 104 via the connection interface 175.

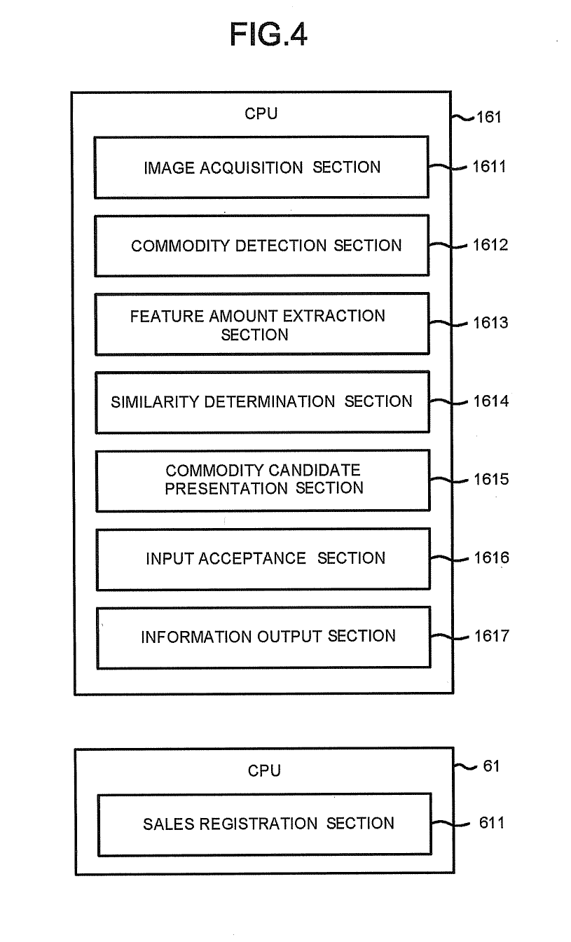

Next, the functional constitution of the CPU 161 and the CPU 61 achieved with the program executed by the CPU 161 and the CPU 61 are described below with reference to FIG. 4.

FIG. 4 is a block diagram illustrating the functional structure of the POS terminal 11 and the commodity reading apparatus 101. As shown in FIG. 4, by executing programs sequentially, the CPU 161 of the commodity reading apparatus 101 functions as an image acquisition section 1611, a commodity detection section 1612, a feature amount extraction module 1613, a similarity determination module 1614, a commodity candidate presentation section 1615, an input reception section 1616 and an information output module 1617.

The image acquisition section 1611 outputs an image capturing-on signal to the image capturing module 164 to start an image capturing operation. The image acquisition section 1611 sequentially acquires images that are captured by the image capturing module 164 and stored in the RAM 163 after the image capturing operation is started. The image acquisition section 1611 acquires the captured images in the order in which the images are stored in the RAM 163.

The commodity detection section 1612 detects whole or part of the outline of a commodity contained in the captured image acquired by the image acquisition section 1611, using a well-known pattern matching technology. Next, the outline extracted from the captured image (frame image) of the last time is compared with that extracted from the frame image of this time to detect a changed part, that is, an area where a commodity G facing the reading window 103 is imaged.

Following is one of other methods for detecting a commodity G. It is detected whether or not a skin color area is detected in the captured image. If the skin color area is detected, that is, the hand of a shop clerk imaged is detected, it is tried to extract the outline of a commodity G which may be held by the shop clerk by performing the above-described outline detection at an area nearby the color skin area. At this time, if a hand-shaped outline and the outline of another object nearby the hand-shaped outline are detected, the area of the commodity G imaged is detected according to the outline of the object.

The feature amount extraction module 1613 extracts the state (external tint, pattern, concave-convex condition and shape) of the surface of the area, in which the commodity G is imaged, detected by the commodity detection section 1612 within the captured image acquired by the image acquisition section 1611 as feature amount of the commodity G (extraction module).

The similarity determination module 1614 compares the feature amount extracted by the feature amount extraction module 1613 with the feature amount of each commodity registered in the PLU file F1 of the POS terminal 11 to calculate the similarity degree indicating the relationship between the two feature amounts. The similarity determination module 1614 recognizes a registered commodity (commodity ID) having a similarity degree calculated greater than a given threshold as a candidate for the commodity G photographed by the image capturing module 164 (recognition module). The similarity degree is at least a value indicating how much similar the feature amount of the commodity G and the feature amount of each commodity registered in the PLU file F1 are to one the other by comparing the two feature amounts. Concept of the similarity degree is not limited to the example above, and it may also be a value indicating the degree of the consistency of the two feature amounts, or a value indicating how much the feature amount of the commodity G and the feature amount of each commodity registered in the PLU file F1 are mutually correlated.

The recognition of an object contained in an image is referred to as a general object recognition, which is carried out by various recognition methods that are respectively illustrated in the following documents:

YANAI Keiji, ‘The current state and further directions on General Object Recognition’, in Proceedings of Information Processing Society of Japan, Vol. 48, No SIG 16, In URL:http://mm.cs.uec.ac.jp/IPSJ-TCVIM-Yanai.pdf [retrieved on Jul. 26, 2012].

In addition, the technology for recognizing a general object by partitioning an image into areas for each article (object) is described in the following document:

Jamie Shotton: ‘Semantic Texton Forests for Image Categorization and Segmentation, In URL:http://citeseerx.ist.psu.edu/viewdoc/download?doi=10.1.1.1 45.3036&rep=repl&type=pdf (retrieved on Jul. 26, 2012).

It does not matter what type of calculation method of the similarity degree. For example, the similarity degree may be calculated as an absolute evaluation or a relative evaluation. If the similarity degree is calculated as an absolute evaluation, the image of the photographed commodity G and each registered commodity are compared one to one, and the similarity degree derived from the result of this comparison can be directly adopted as it is. If the similarity degree is calculated as a relative evaluation, the similarity degree may be calculated so that the sum of the similarity degrees between the photographed commodity G and each registered commodity is 1.0 (100%)

The commodity candidate presentation section 1615 displays, on the display device 106, the information concerning the registered commodity recognized by the similarity determination module 1614 as a candidate of recognition commodity.

Specifically, the commodity candidate presentation section 1615 determines whether or not disparate sales information is added to a registered commodity recognized as a candidate (determination module). If disparate sales information is added to the registered commodity, the records of the commodity registered as disparate sales information and the registered commodity recognized as a candidate are read from the PLU file F1 of the POS terminal 11 and displayed on the display device 106. On the other hand, if no disparate sales information is registered on the registered commodity recognized as a candidate, the record of the registered commodity recognized is read from the PLU file F1 of the POS terminal 11 and displayed on the display device 106.

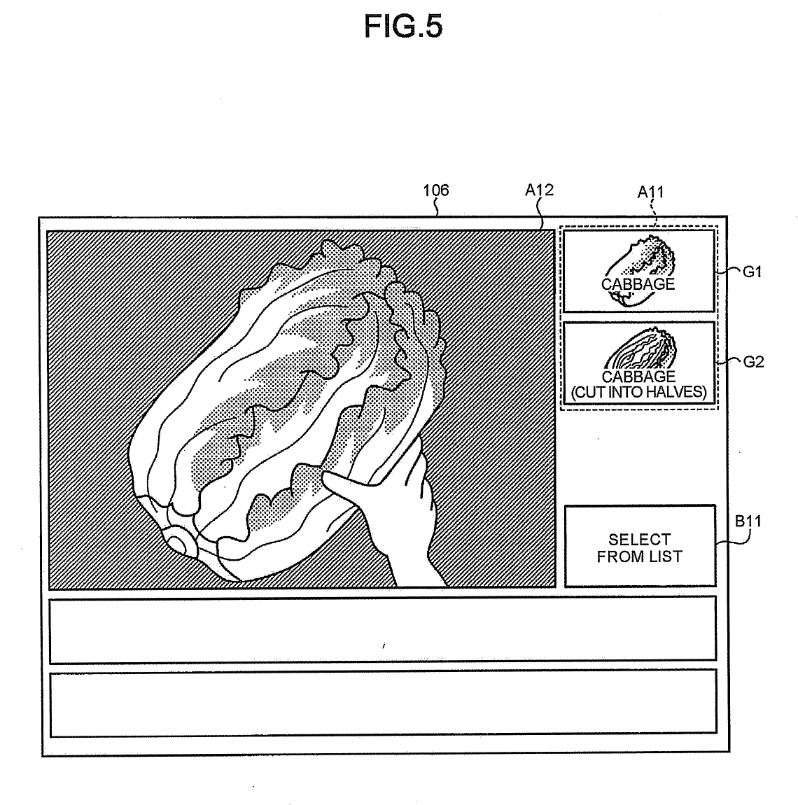

FIG. 5 is a diagram illustrating an example of the display of a commodity candidate. As shown in FIG. 5, in a commodity candidate presentation area A11 on the display screen of the display device 106, the commodity images G1 and G2 and the commodity names those of contained in the records of the commodity candidates are displayed in descending order of similarity degrees of registered commodities. The commodity images G1 and G2 can be selected according to the touch-operation on the touch panel 105. A selection button B11 is arranged at the lower part of the commodity candidate presentation area A11 to select a commodity from a commodity list, and the commodity selected from the commodity list is processed as a determined commodity described later. In an area A12, the image captured by the image capturing module 164 is displayed.

Depending on the photographing direction of the image capturing module 164 to a commodity G, there may be a case in which it is difficult to recognize the sales form of the commodity G according to the captured image. For example, as shown in FIG. 5, if the leaf surface (uncut surface) of a chinese cabbage is photographed, it is difficult to determine whether or not the commodity is sold in the whole unit or in a cut unit (for example, cut into halves) according to the captured image. In this case, even if a commodity sold in a half unit faces the image capturing module 164, the commodity is still recognized as being sold in the whole unit. Therefore, there is a problem that the recognition rate decreases.

According to the present embodiment, if disparate sales information is added to a registered commodity recognized by the similarity determination module 1614 as a candidate, that is, if there is a commodity sold in a disparate sales form in the same commodity as the candidate commodity, records of the candidate commodity and the commodity sold in a disparate sales form are separately displayed as commodity candidates. As a result, even if a commodity G is photographed in a direction from which the sales form of the commodity G is difficult to recognize, the operator can select the commodity G as a correct candidate from the candidate commodity and commodities sold in disparate sales forms, resulting in an improvement in convenience.

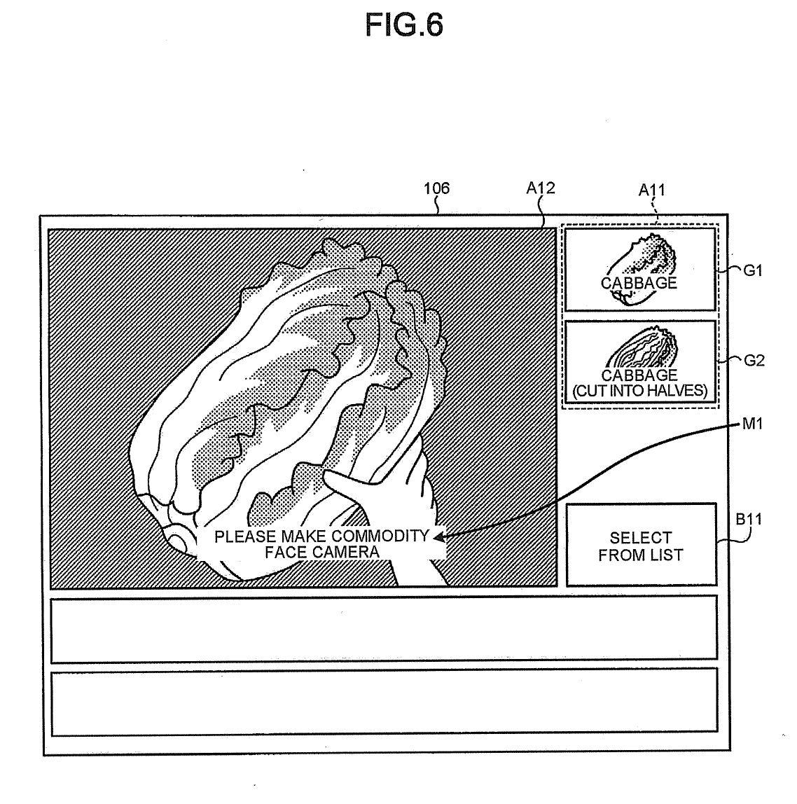

Examples of the display of the commodity candidate are not limited to that in FIG. 5. For example, if a registered commodity recognized as a candidate has disparate sales information, information that prompts an operator to photograph a part of the commodity (e.g. cut surface) reflecting the sales form of the disparate sales commodity to correctly recognize the commodity may be displayed on the display device 106 (refer to M1 shown in FIG. 6), as shown in FIG. 6. As a result, even if an uncut surface of the commodity is photographed in the commodity sold in a half unit, the operator is prompted to photograph the cut surface, and thus the recognition rate of the commodity G can be improved.

In the present embodiment, according to the presence of disparate sales information, it is determined whether or not a disparate sales commodity exists in the registered commodity recognized as a candidate. However, it is not limited to this. For example, the feature amount extracted by the feature amount extraction module 1613 may be used to determine whether or not there is a commodity sold in a disparate sales form.

For example, it is a common way that a commodity (vegetable or fruit) cut into halves is wrapped with a plastic film. Thus, if an information or data indicating the existence of the wrapping material added over the commodity G as a feature amount of the commodity G (e.g. a reverse portion of image caused by the light reflected from a wrapping material) is obtained, then it is determined that a disparate sales commodity exists in the registered commodity which becomes a candidate for the commodity G, and the registered commodity (candidate of the commodity G) can be presented together with the same commodity sold in a disparate sales form indicated with a disparate sales information. Further, if no feature amount representing the existence of the wrapping material is acquired, even if the registered commodity that becomes a candidate is added with disparate sales information, the disparate sales commodity represented by the disparate sales information is not presented.

Returning to FIG. 4, the input reception section 1616 receives various input operations corresponding to the display of the display device 106 through the touch panel 105 or keyboard 107. For example, the input reception section 1616 receives the selection operation of any one of the commodity candidates displayed on the display device 106. The input reception section 1616 receives the commodity candidate selected as a commodity corresponding to the commodity G (determined commodity) photographed by the image capturing module 164. If a plurality of commodities G are detected by the commodity detection section 1612, the input reception section 1616 may receive the selection operation of plural commodity candidates from the plurality of commodity candidates.

The information output module 1617 outputs, information (e.g. commodity ID and commodity name) representing the commodity determined as described above to the POS terminal 11 through the connection interface 175 (output module).

The information output module 1617 may further output the number of sales amounts separately input from the touch panel 105 or keyboard 107 to the POS terminal 11. As information output from the information output module 1617 to the POS terminal 11, a commodity ID read by the information output module 1617 from the PLU file F1 may be notified, directly, or a commodity name capable of specifying a commodity ID and the file name of a commodity image may also be notified, or the storage location (storage address in the PLU file F1) of the commodity ID may still be notified.

On the other hand, by executing a program, the CPU 61 of the POS terminal 11 functions as a sales registration section 611. The sales registration section 611 registers the sales of a commodity based on the commodity ID and the number of sales amounts of the commodity output from the information output module 1617 of the commodity reading apparatus 101. Specifically, referring to the PLU file F1, the sales registration section 611 performs the sales registration by recording the notified commodity ID, and the commodity category, the commodity name, and the unit price corresponding to the commodity ID, together with the number of sales amounts in a sales master file.

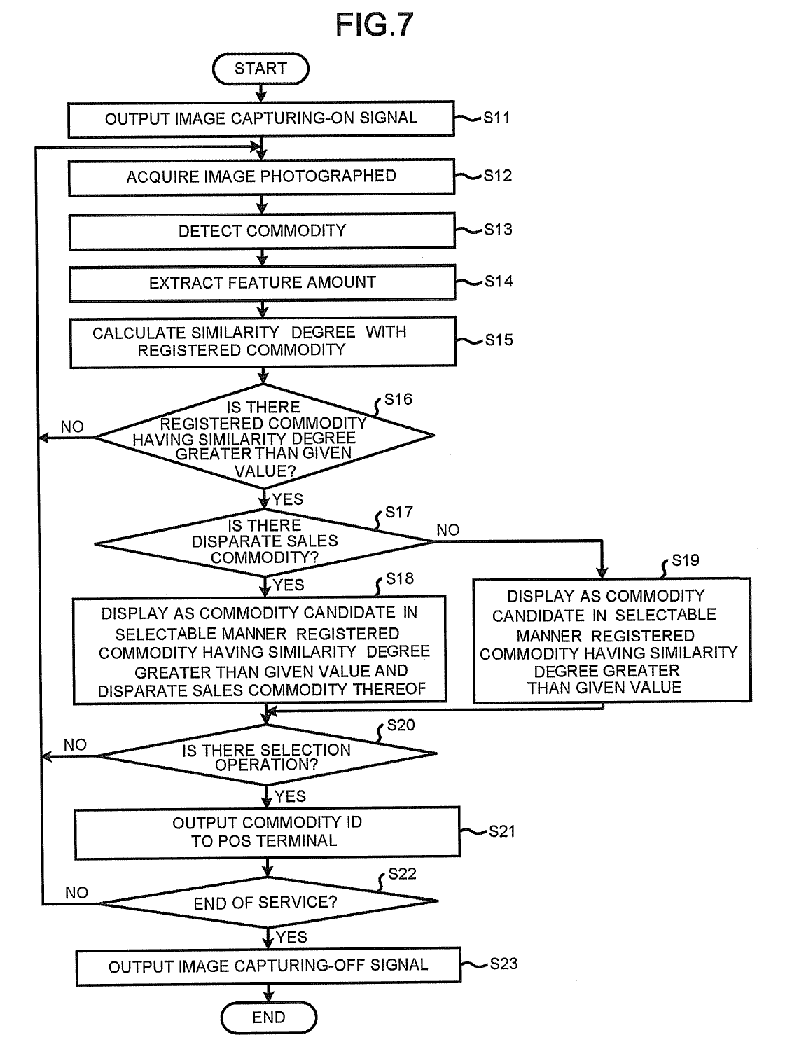

Next, operation of the checkout system 1 is described. The operation of the commodity reading apparatus 101 is described first. FIG. 7 is a flow chart illustrating the procedure of a commodity recognition processing carried out by the commodity reading apparatus 101.

As shown in FIG. 7, the image acquisition section 1611 outputs an image capturing-on signal to the image capturing module 164 to start the image capturing of the image capturing module 164 (ACT S11) when the processing is started in response to the start of the commodity registration by the POS terminal 11.

The image acquisition section 1611 sequentially acquires frame images that are captured by the image capturing module 164 and are stored in the RAM 163 (ACT S12). Next, the commodity detection section 1612 detects whole or part of a commodity G from the captured image acquired in the ACT S12 (ACT S13). The feature amount extraction module 1613 extracts the feature amount of the commodity G detected in the ACT S13 from the captured image acquired in the ACT S12 (ACT S14).

The similarity determination module 1614 calculates the similarity degree between the feature amount extracted in the ACT S14 and the feature amount of each registered commodity in the PLU file F1 of the POS terminal 11 (ACT S15). The similarity determination module 1614 determines whether or not there is a registered commodity having the feature amount extracted in the ACT ST14 higher than a threshold within the registered commodities the similarity degree of which is calculated in the ACT S15 (ACT S16).

If it is determined that there is a registered commodity the similarity degree of which is higher than the threshold (YES in ACT S16), the feature amount extraction module 1613 recognizes the registered commodity as a candidate for the commodity G photographed by the image capturing module 164, and then, Otherwise, the ACT S12 is taken again.

Sequentially, in the ACT S17, the commodity candidate presentation section 1615 determines, based on whether or not disparate sales information is added to the registered commodity recognized as a candidate in the ACT S16, whether or not a commodity sold in a disparate sales form different from the sales form of the registered commodity exists in the registered commodity (ACT S17). If the feature amount extracted by the feature amount extraction module 1613 or the comparison result of the similarity determination module 1614 is used to determine whether or not there is a disparate sales commodity, the commodity candidate presentation section 1615 performs the determination operation in the ACT S17.

If it is determined that there is a disparate sales commodity (YES in ACT S17), the commodity candidate presentation section 1615 reads the records corresponding to the registered commodity recognized as a candidate in the ACT S16 and corresponding to a registered commodity indicated by the disparate sales information added to the registration information of the registered commodity from the PLU file F1 of the POS terminal 11 and makes the display device 106 display them as a commodity candidate (ACT S18). On the other hand, if it is determined that there is no disparate sales commodity (NO in ACT S17), the commodity candidate presentation section 1615 reads the record of the registered commodity recognized as a candidate in the ACT S16 from the PLU file F1 of the POS terminal 11 and makes the display device 106 display the registered commodity as a commodity candidate (ACT S19). It should be noted that if there is no disparate sales commodity (NO in ACT S17), the ACT S19 is skipped over, and one commodity candidate having the highest similarity degree may be output.

Then, the input reception section 1616 determines whether or not the selection on a commodity candidate is received through the touch panel 105 or keyboard 107 (ACT S20). If the selection operation is received (YES in ACT S20), the input reception section 1616 receives the selected commodity candidate as a determined commodity corresponding to the commodity G photographed by the image capturing module 164, and then, the ACT S21 is taken. On the other hand, if no selection operation is received (NO in ACT S20), the ACT S12 is taken again.

Next, the information output module 1617 outputs information (commodity ID and the like) representing the determined commodity which is selected in the ACT S23 to the POS terminal 11 through the connection interface 175 (S21), and then the ACT S22 is taken.

If the number of sales amounts is separately input through the touch panel 105 or the keyboard 107, the number of sales amounts is also output to the POS terminal 11 along with the information indicating the determined commodity in the ACT S21. In addition, if the number of sales amounts is not input, ‘1’ (one) may be output as a default value of the number of sales amounts.

Then, the CPU 161 determines whether or not there is a termination of service, e.g., notification for termination of the commodity registration, sent from the POS terminal 11 (ACT S22). If the service is to be continued (NO in ACT S22), the CPU 161 returns to execute the ACT S12 to continue the processing. On the other hand, if the service is to be ended (YES in ACT S22), the image acquisition section 1611 outputs an image capturing-off signal to the image capturing module 164 to end the image capturing of the image capturing module 164 (ACT S23), then the processing is ended.

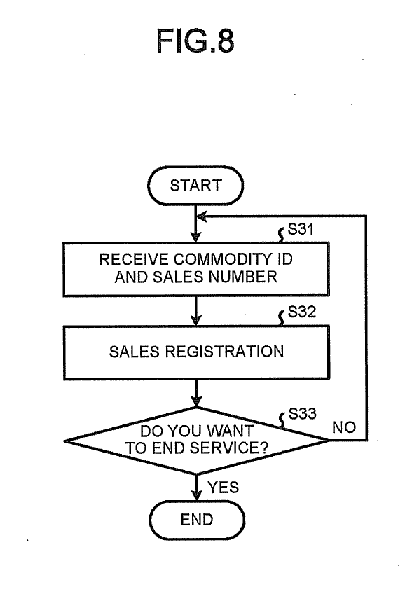

Next, the processing operation carried out by the POS terminal 11 is described. FIG. 8 is a flow chart illustrating the procedure of a sales registration processing carried out by the POS terminal 11.

First, when a commodity registration processing is started according to an operation instruction from the keyboard 22, the CPU 61 receives the commodity ID and the number of sales amounts of the determined commodity output in the ACT S21 shown in FIG. 7 (ACT S31). Then, the sales registration section 611 reads the commodity category and the unit price from the PLU file F1 based on the commodity ID and the number of sales amounts received in the ACT S31, and registers the sales of the commodity G read by the commodity reading apparatus 101 in the master file (ACT S32).

Sequentially, the CPU 61 determines whether or not there is a termination of service, e.g., termination of sales registration, instructed through the keyboard (ACT S33). If the service is to be continued (NO in ACT S33), the CPU 61 returns to the ACT S31 to continue the processing. If the service is to be ended (YES in ACT S33), the CPU 61 ends the processing.

As stated above, in accordance with the present embodiment, if there is a commodity sold in a disparate sales form different from the sales form of the registered commodity that is determined as a candidate of the commodity G, information concerning the disparate sales commodity and information concerning the registered commodity are presented together as a selectable commodity candidate. Thus, even if the commodity G is sold in a whole unit and in a cut state (e.g. cut into halves), the selection can also be made on the commodity G cut into halves as a commodity candidate when the commodity is recognized as a commodity sold in a whole unit. Therefore, operability of the user can be enhanced and recognition on a disparate sales commodity can also be effectively executed. In the present embodiment, a commodity G cut into halves is described as an example of processed commodity, however, the commodity G may also be cut into quarters (¼).

While certain embodiments have been described, these embodiments have been presented by way of example only, and are not intended to limit the scope of the present invention. Indeed, the novel embodiments may be embodied in a variety of other forms; furthermore, various omissions, substitutions and changes in the form of the embodiments may be made without departing from the spirit of the present invention. The accompanying claims and their equivalents are intended to cover such forms or modifications as would fall within the scope and spirit of the present invention.

For example, in the embodiments described herein, the POS terminal 11 is equipped with the PLU file F1. However, it is not limited to this, and the commodity reading apparatus 101 may be equipped with the PLU file F1 in a whole or a part thereof, instead.

Further, in the embodiments described herein, a commodity candidate is recognized by the commodity reading apparatus 101. However, the POS terminal 11 is provided with the functional section of the commodity reading apparatus 101 and thus may perform the recognition processing. In this case, the commodity reading apparatus 101 functions as an image capturing device, and the POS terminal 11 recognizes and determines a commodity candidate based on a captured image (frame image) sent from the commodity reading apparatus 101.

Further, in the embodiments described herein, a scanner device of a stationary type (commodity reading apparatus 101) is used. However, it is not limited to this, and a so-called handy type scanner may be connected with the POS terminal 11.

Further, in the embodiments described above, the present invention is applied to the commodity reading apparatus 101 in a checkout system 1 consisting the POS terminal 11 and the commodity reading apparatus 101. However, it is not limited to this, and the present invention may also be applied to a single apparatus equipped with functions of the POS terminal 11 and the commodity reading apparatus 101 in one housing, or a checkout system, for example, in which the commodity reading apparatus 101 and the POS terminal 11 shown in FIG. 1 are connected to one another in a wired or wireless manner. As a single apparatus equipped with functions of the POS terminal 11 and the commodity reading apparatus 101, a self-checkout apparatus (hereinafter referred to as a self-checkout POS) installed in a store or supermarket can be given.

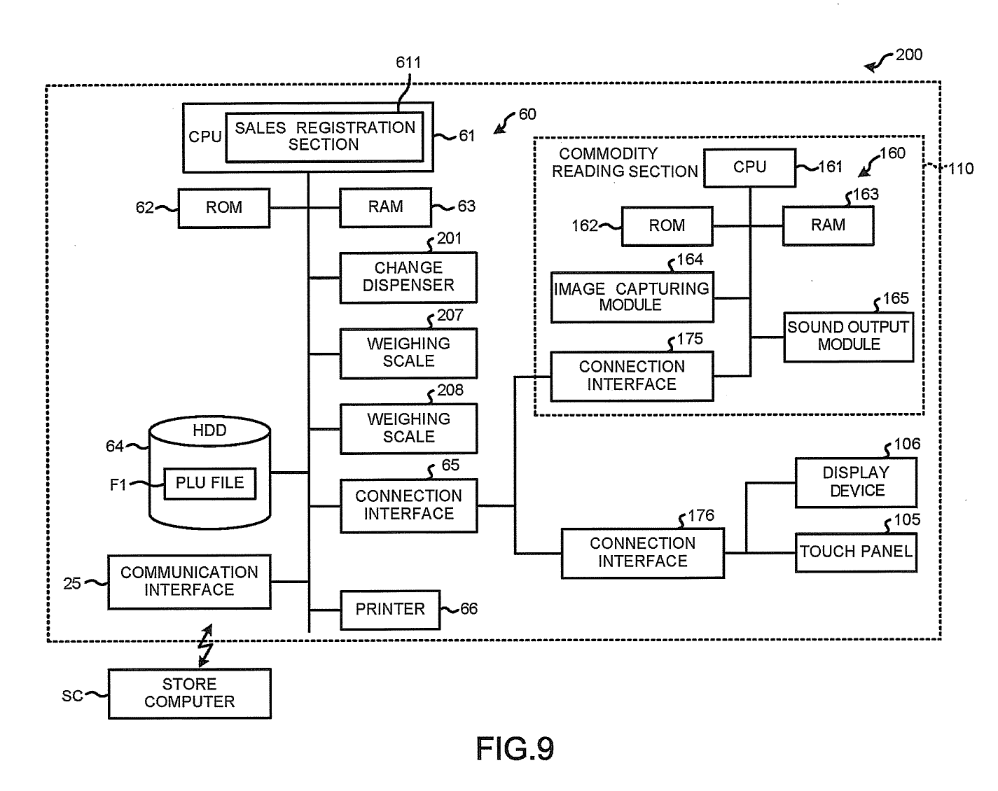

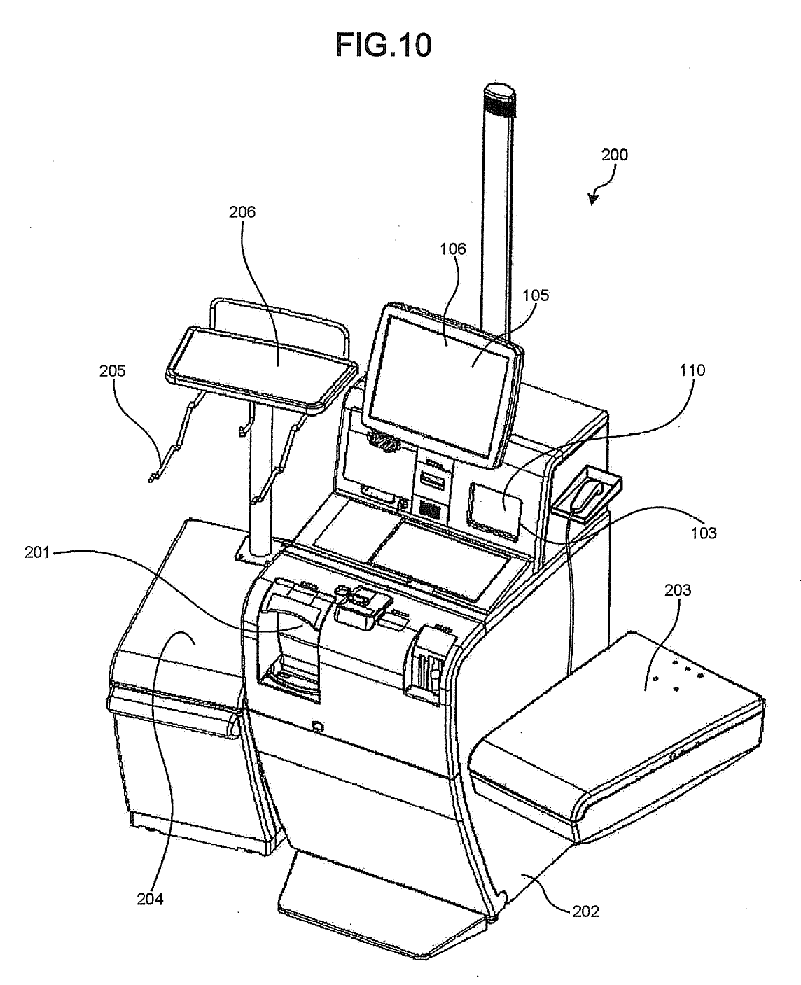

FIG. 9 is a perspective view of the external constitution of a self-checkout POS 200, and FIG. 10 is a block diagram illustrating the hardware constitution of the self-checkout POS 200. In FIGS. 9 and 10, same numerals are applied to constitutions similar to those shown in FIG. 1 and FIG. 2 and therefore explanations those of are not repeated.

As shown in FIG. 9 and FIG. 10, the main body 202 of the self-checkout POS 200 includes a display device 106 having a touch panel 105 on the surface thereof and a commodity reading unit 110 which reads a commodity image to recognize (detect) the category of the commodity.

A liquid crystal display is used as the display device 106, for example. The display device 106 displays a guidance screen for providing a guidance of the operation of the self-checkout POS 200 to the customer, various input screens, a registration screen for registering the commodity information read by the commodity reading unit 110 and a settlement screen for selecting method of payment on which the total amount of commodities, a deposit amount (provisional payment) and a change amount are displayed.

The commodity reading unit 110 reads a commodity image, using an image capturing module 164, which captures image of the commodity when the customer holds a code symbol affixed on the commodity over the reading window 103 of the commodity reading unit 110.

A first commodity receiving table 203 for placing unsettled commodities housed in a basket is provided at the right-hand side of the main body 202. A second commodity receiving table 204 for placing settled commodities is provided at left-hand side of the main body 202. A bag hook 205 for holding a bag into which the settled commodities are taken is arranged above the second commodity receiving table 204 and a temporary receiving table 206 for temporarily placing the settled commodities before taking the settled commodities into the bag is arranged at the left-hand side of the main body 202. Weighing scales 207 and 208 are respectively provided to the first and second commodity receiving tables 203 and 204 to confirm weight of a commodity before and after the settlement operation whether or not the weight of the commodity is unchanged after the commodity is settled.

A change device 201 for depositing and dispensing bill for settlement is arranged in the main body 202 of the self-checkout POS 200.

In the case in which the present invention is applied to the self-checkout POS 200 having the constitution described above, the self-checkout POS 200 functions as an information processing apparatus. A single apparatus having functions of the POS terminal 11 and the commodity reading apparatus 101 is not limited to the self-checkout POS 200 described above and may be constructed without the weighing scales 207 and 208, which are installed in the self-checkout POS 200.

Further, in the embodiments above, the programs executed by each apparatus are pre-compiled in the storage medium (ROM or memory unit) of the apparatus, however, the present invention is not limited to this, the programs may be stored as in a computer-readable recording medium such as CD-ROM, flexible disk (FD), CD-R, DVD (digital versatile disk) as an installable or executable file. Moreover, the storage medium, which is not limited to a medium independent from a computer or an assembled system, may include a storage medium which downloads the programs that are transmitted over an LAN or the Internet and then stored or temporarily stored.

In addition, the programs executed by each apparatus may be stored in a computer connected with a network such as the Internet to be provided after being downloaded from the network or provided or issued by a network such as the Internet.

Further, the programs involved in the embodiment above may also be installed in a portable information terminal with a communication function, such as a mobile telephone, a smart phone, a PDA (Personal Digital Assistant).

While certain embodiments have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An information processing apparatus, comprising:
an image capturing module configured to photograph a commodity;
an extraction module configured to extract a feature amount of the commodity contained in the image photographed by the image capturing module;
a recognition module configured to recognize the commodity as a commodity candidate in the feature amount the commodity by the extraction module;
a determination module configured to determine whether or not there is a commodity sold in a disparate sales form for a standard commodity which is recognized by the recognition module as a candidate; and
an output module configured to output in a selectable manner information concerning the standard commodity recognized by the recognition module as a candidate and the commodity sold in a disparate sales form for the standard commodity if the determination module determines that there is a commodity sold in a disparate sales form.

2. The information processing apparatus according to claim 1, wherein
the determination module determines whether or not there is a commodity sold in a disparate sales form for the standard commodity, which is recognized by the recognition module as a candidate, based on a data which associates a standard commodity sold in a disparate sales form, as a disparate sales commodity, with a registered commodity sold in a specific sales form different from the disparate sales form in the same standard commodity.

3. The information processing apparatus according to claim 2, wherein
the standard commodity sold in the specific sales form is sold in a whole unit, and the standard commodity sold in the disparate sales form different from the specific sales form is a product that the standard commodity sold in a whole unit is processed.

4. The information processing apparatus according to claim 1, wherein
the determination module determines that there is a disparate sales commodity if the feature amount extracted by the extraction module includes information showing existence of a specific addition added to the commodity.

5. The information processing apparatus according to claim 1, wherein
the output module outputs an information which prompts a person to photograph a part of the commodity capable of recognizing the sales form of the disparate sales commodity if it is determined that there is a disparate sales commodity.

6. An information processing method, including:
photographing a commodity;
extracting a feature amount of the commodity contained in the photographed image;
recognizing the commodity as a commodity candidate in the feature amount the commodity;
determining whether or not there is a disparate sales commodity sold in a form different from a standard commodity which is recognized as a candidate; and
outputting in a selectable manner information concerning the standard commodity recognized as a candidate and the disparate sales commodity of the standard commodity if it is determined that there is a disparate sales commodity.

7. The information processing method according to claim 6, wherein
the determining whether or not there is a disparate sales commodity is performed based on the data which associates a standard commodity sold in a disparate sales form, as a disparate sales commodity, with a registered commodity sold in a specific sales form different from the disparate sales form in the same standard commodity.

8. The information processing method according to claim 6, wherein
the standard commodity sold in the specific sales form is sold in a whole unit, and the standard commodity sold in the disparate sales form different from the specific sales form is a product that the standard commodity sold in a whole unit is processed.

9. The information processing method according to claim 6, wherein
the determining whether or not there is a disparate sales commodity determines that there is the disparate sales commodity if the extracted feature amount includes the information showing existence of a specific addition added to the commodity.

10. The information processing method according to claim 6, wherein
the outputting in a selectable manner includes outputting information which prompts a person to photograph a part of the commodity capable of recognizing the sales form of the disparate sales commodity if it is determined that there is a disparate sales commodity.
